(19) United States
(12) Patent Application Publication
(10) Pub. No.: US 2025/0345159 A1
(43) Pub. Date: Nov. 13, 2025

(54) STAND TO HOLD AND ROTATE STUMP PEGS

(71) Applicant: Brent Wulfenstein, Salem, UT (US)

(72) Inventor: Brent Wulfenstein, Salem, UT (US)

(21) Appl. No.: 19/207,260

(22) Filed: May 13, 2025

Related U.S. Application Data
(60) Provisional application No. 63/646,386, filed on May 13, 2024.

(51) Int. Cl. A61C 13/08

(52) U.S. Cl. CPC A61C 13/08

(57) ABSTRACT

A device for rotating one or more artificial dental teeth is disclosed, comprising an upper element having top surface that defines at least one positioning opening capable of receiving a stem, the stem extending between an attaching end and a tooth end, the tooth end capable of holding one or more artificial dental teeth, a lower element having a bottom surface, the lower element capable of moving in a circular motion in relationship with the upper element; a securing element disposed between the top surface of the upper element and the bottom surface of the lower element, the securing element capable of securely holding the stem at a location proximal towards the attaching end within the device; and a turning system disposed between the top element and bottom element, the turning system capable of spinning the stem within the securing element; whereas by moving the lower element in a circular motion against the upper element, the turning system is thereby engaged to spin the stem within the securing element.

### RELATED APPLICATION

This application claims priority from U.S. Provisional Application No. 63/646,386 filed on May 13, 2024 and entitled “Stand to Hold Stumps Pegs and Rotate Them,” the entire contents of which are hereby fully incorporated herein.

### BACKGROUND OF THE INVENTION

The invention solves messy unorganized and cumbersome methods for holding stump pegs. In the existing art, when the pegs that hold work-in-progress dental restorations are fixed in place, it can make access to all surfaces of the dental restorations difficult to reach with a brush or other working tools. Other systems require pieces to be cut and glued together to make bridge pegs when creating custom dental restorations.

Other devices do not have a convenient way to hold odd size bridges. Other devices do not allow movement of the pegs in unison.

A need exists for easy assembly of pre-made pieces to form custom pegs for holding bridges with any number of pontic and abutment teeth. A need further exists for a specialized peg that fits the base which is designed to allow the user to rotate all of the pegs in unison. A need further exists for a universal base and stand for working on dental restorations for different projects, so that a dental technician may concurrently address different projects in different layers that require curing, drying and other time-delaying and sensitive stages on the same stand.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIGS. 1a and 1b shows a top perspective view of a base of the device, according to an embodiment of the invention.

FIG. 2 shows a view of a center sun gear atop the base the device, according to an embodiment of the invention.

FIGS. 3a and 3b show views of a spur gear or planetary gear positioned around the sun gear of the device, according to an embodiment of the invention.

FIG. 4 shows a ring gear the device, according to an embodiment of the invention.

FIGS. 5a and 5b shows a cage for the sun gear of the device, according to an embodiment of the invention.

FIGS. 6a and 6b show a top perspective and a bottom perspective view of a sleeve for the sun gear of the device, according to an embodiment of the invention.

FIGS. 7a and 7b show a side and a bottom perspective view of a top element of the device, according to an embodiment of the invention.

FIG. 8 shows a tapered gear peg or stem for holding an artificial tooth or teeth on the device, according to an embodiment of the invention.

FIG. 9 shows a tapered peg bottom for attaching a bridge connector on the device, according to an embodiment of the invention.

FIG. 10 shows a partial peg top between the bridge connector and an artificial tooth for use with the device, according to an embodiment of the invention.

FIG. 11 shows a bridge connector for addressing multi-tooth restorations onto a single opening of the device, according to an embodiment of the invention.

FIGS. 12a and 12b depict a side exploded view and a bottom perspective exploded view of the constituent parts of the device, according to an embodiment of the invention.

FIGS. 13a and 13b depict top perspective views of a device with a single stump in place to hold an artificial dental tooth.

FIG. 14 depicts a multi-bridge connector for use atop the inventive device, according to an embodiment of the invention.

FIG. 15 depicts a device with different artificial teeth festooned upon individual peg stumps or stems, according to an embodiment of the invention.

FIG. 16 depicts a bridge connector setup upon a stump in the device, which may resemble an archform workflow according to an embodiment of the invention.

FIG. 17 depicts a stump positioned securely in the gear of the device according to an embodiment of the invention.

FIG. 18 depicts a gearless embodiment of the device, according to an embodiment of the invention.

FIG. 19 depicts a linear device having a lever action, according to an embodiment of the invention

FIG. 20 depicts a linear device having a gear action, according to an embodiment of the invention

FIGS. 21a-b depict a different linear device having a lever action, according to an embodiment of the invention

### SUMMARY OF THE INVENTION

A first embodiment of the invention may comprise a device for rotating one or more artificial dental teeth, the device is disclosed, comprising an upper element having top surface that defines at least one positioning opening capable of receiving a stem, the stem extending between an attaching end and a tooth end, the tooth end capable of holding one or more artificial dental teeth, a lower element having a bottom surface, the lower element capable of moving in a circular motion in relationship with the upper element, a securing element disposed between the top surface of the upper element and the bottom surface of the lower element, the securing element capable of securely holding the stem at a location proximal towards the attaching end within the device, a turning system disposed between the top element and bottom element, the turning system capable of spinning the stem within the securing element; whereas by moving the lower element in a circular motion against the upper element, the turning system is thereby engaged to spin the stem within the securing element, the upper element or the lower element having a disc-like shape with a perimeter having a surface with a gripping feature, whereas either the upper element or the lower element may be engaged to communicate a circular motion to the turning system

the turning system comprising a center sun gear comprising a curved perimeter having at least one cog, a spur gear having a curved perimeter with at least one cog, the spur gear disposed exterior of and capable of communicating circular motion to the center sun gear, a ring gear disposed exterior of the spur gear, the ring gear having a curved perimeter having at least one cog, the ring gear capable of communicating circular motion to the at least one cog of the spur gear, the spur gear further having a top surface defining a securing element where stem seats into the spur gear, whereas the stem, center sun gear, spur gear and ring gear are capable of communicating motion in a forward and reverse circular motion, the device further comprising a cage disposed between the upper element and the turning system, the cage having a top surface and a bottom surface that define at least one opening capable of receiving the stem therethrough; and a modular bridge connector for use with the device of the first embodiment of the invention, the modular bridge connector capable of seating upon the tooth end of a stem, the modular bridge connector having a top surface and a bottom surface that define at least one opening capable of receiving the stem, the modular bridge connector having a number of openings between 2 and 15, the modular bridge connector of further comprising a partial peg bottom stump for connecting between a modular bridge connector and the turning system, the modular bridge connector further comprising a partial peg top comprising a tooth end and an attaching end, the partial peg top capable of connecting a second modular bridge connector positioned atop the modular bridge connector, whereas the tooth end of the partial peg top is positioned distal of the modular bridge connector, the second modular bridge connector and the device, whereas the modular bridge connector is capable of supporting the assembly of a customized configuration of a dental restoration on a stem, whereas the one or more stems spin in unison, the device comprising one or more stems, whereas the one or more stems spin in unison when the turning system is engaged, the modular bridge connector, second modular bridge connector, partial peg top and partial peg bottom being capable of allowing assembly to fit a customized configuration of a dental restoration on a stem.

In a second embodiment of the invention, a device for rotating one or more artificial dental teeth, the device may comprise a stem extending between an attaching end and a tooth end of the stem, the tooth end of the stem capable of securing one or more artificial dental teeth, a securing element capable of holding the stem in a fixed vertical position, the securing element capable of fixing the attaching end of the stem to the device, a turning system capable of turning the stem in an arcuate direction while remaining in a fixed vertical position; whereas the arcuate direction of the stem translates to a turning of the one or more artificial dental teeth; and a modular bridge connector for use with the device of second embodiment, the modular bridge connector capable of seating upon the tooth end of a stem, the modular bridge connector having a top surface and a bottom surface that define at least one opening capable of receiving the stem, the modular bridge connector further comprising a partial peg bottom stump for connecting between a modular bridge connector and the turning system, the modular bridge connector further comprising a partial peg top comprising a tooth end and an attaching end, the partial peg top capable of connecting a second modular bridge connector positioned atop the modular bridge connector, whereas the tooth end of the partial peg top is positioned distal of the modular bridge connector, the second modular bridge connector and the device, whereas the modular bridge connector is capable of supporting the assembly of a customized configuration of a dental restoration on a stem, the device further comprising a plurality of stems, whereas the plurality of stems spin in unison when the turning system is engaged, the turning system capable of turning the stem in a full circular rotation, the turning system further comprising a one or more joining elements, the one or more joining elements being positioned between each of the plurality of stems, the one or more joining elements being capable of conveying a turning motion to the plurality of stems, whereas by applying a turning motion to either an individual joining elements or to an individual stem, the turning motion is communicated to all of the one or more joining elements and the plurality of stems.

In a third embodiment of the invention, a method for positioning and rotating one or more artificial dental teeth may comprise fixing a plurality of stump pegs into a base device that fixes the plurality of stump pegs in a vertical position, applying one or more unfinished artificial dental teeth to a stump peg, modifying the construction of the unfinished artificial dental teeth, communicating a circular motion to the plurality of stump pegs while maintaining a fixed vertical position, conveying the circular motion from the plurality of stump pegs to the unfinished artificial teeth to position desirable to complete work on the unfinished artificial teeth, and optionally adding a modular bridge connector and connecting pieces between the base device and the unfinished artificial teeth.

### DETAILED DESCRIPTION OF THE INVENTION

The present invention solves messy unorganized and cumbersome methods for holding stump pegs. The present invention provides a spinning mechanism for each stump peg, with sufficient space to work independently on each stump peg. The present invention provides a solution for lab technicians to address 360 degrees of multiple artificial teeth, independently or in a multi-unit restoration, on a single stand. The invention provides an efficient way to work on different cases at the same time, staggering out the timing between tasks between the different cases. The invention even further provides a structure for creating and finishing a bridge of artificial teeth, lined together yet still capable of spinning a single stump peg upon which the connecting bridge structure rests. The invention ever further provides the ability for a dental technician to stay seated in the same position, while turning the desired angle of the constructed dental tooth or teeth towards the technician. The invention provides a stand for spinning multiple pieces of independent stems of dental restorations in unison. The invention ever further provides the ability to build customized dental restorations like bridges upon modular bridge connections.

This invention consists of a base that holds specialized pegs designed for holding dental crowns, veneers and bridges. The specialized peg system rests securely in the base. The base holds and allows movement of the pegs in unison. The present invention is a clean and organized method to hold the dental restorations while staining and glazing.

The claimed invention differs from what currently exists. This is a cleaner method of holding pegs than most other systems. Critical improvements in artificial dental teeth construction and workflow are the movement of the stem or pegs, the way they interlock with each other and the adaptability for use with dentures, single unit or crown and bridgework.

The invention further allows for easy assembly of premade pieces to form custom pegs for holding bridges with any number of Pontic and abutment teeth. It also has a specialized peg that fits the base which is designed to allow the user to rotate all of the pegs in unison.

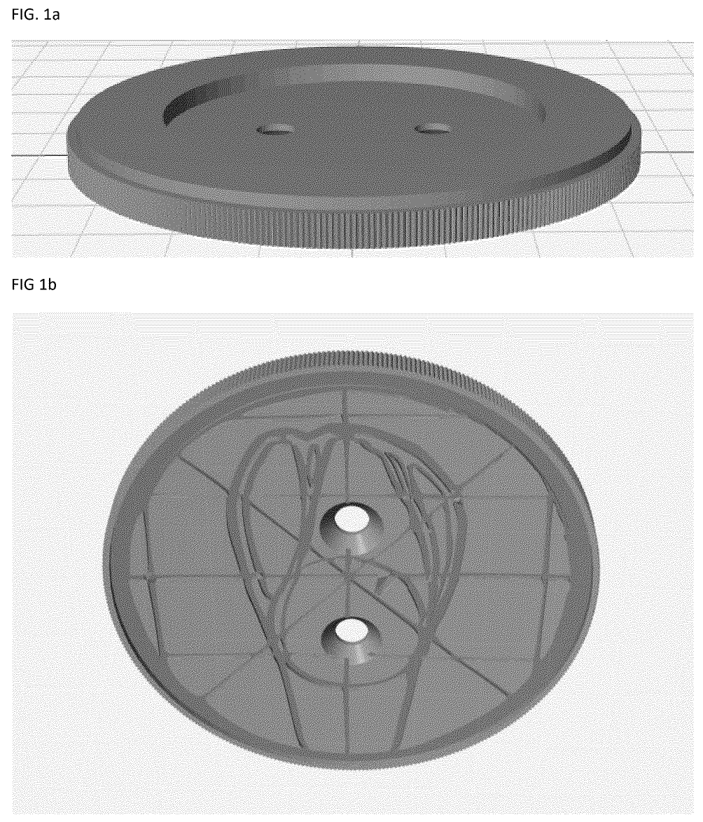

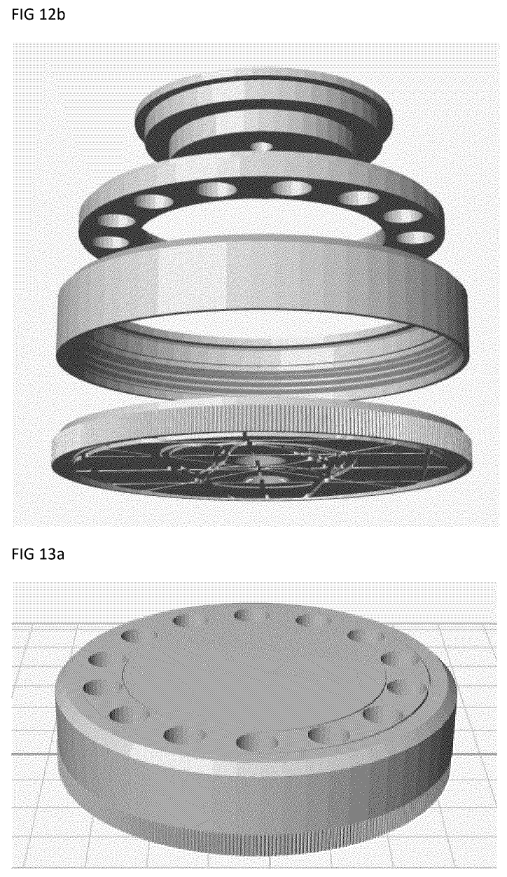

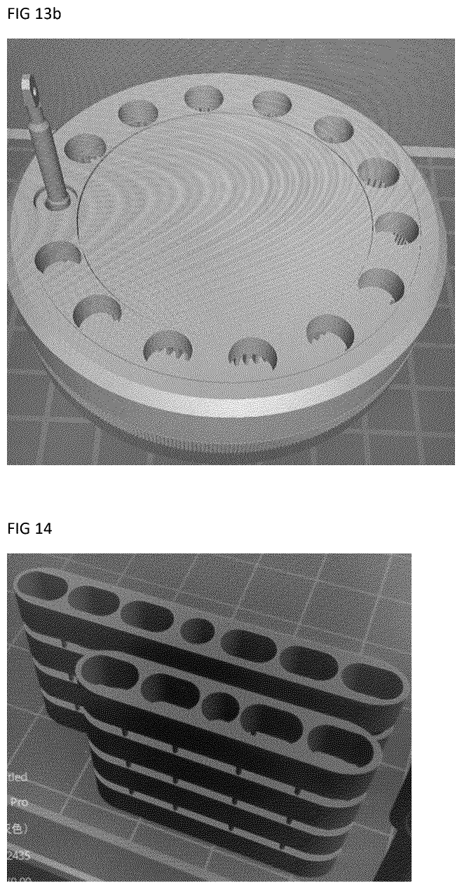

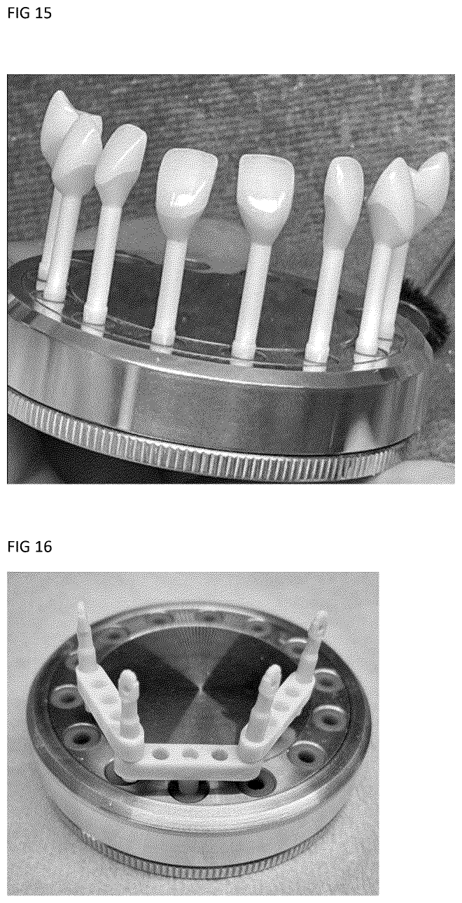

In an embodiment of the invention, a base or lower element is shown in FIGS. 1a and 1b, which may be a platform upon which inventive device built, as can be seen in the exploded view of FIGS. 12a and 12b. The base is shown as being a disc-like shape, but may have other shapes in other embodiments of the invention. The base is shown as having a perimeter with a curved profile. The perimeter of the base is shown to have surface application or features that are capable of easy grip. As shown in FIG. 1, a gripping feature is indicated with vertical lines that may be perpendicular to a bottom surface of the base seen in FIG. 1b, or a top surface of base shown in FIG. 1a. In other embodiments, the gripping feature may resemble other surface etchings, treatments, machinations or millings by any manufacturing process known in the arts to create a gripping feature. In another embodiment of then invention, the upper element includes a gripping feature at a surface of its perimeter. In yet another embodiment of the invention, either the upper element or the lower element may be utilized and structured to be the primary turning element of the device to communicate circular rotation to the turning system and in turn, the stem. The bottom and top surfaces of base may define one or more base openings capable of receiving a connecting screw, peg, press fit, snap fit, spring, rubber or elastomeric form, cylinder, or other structure capable of tying together the features of the device described herein in a compressive, locked or simply tied down manner. As shown in FIG. 1b, the bottom surface of the base may have removed portions about the base openings to accommodate the head of a screw or other needed features to incorporate the connecting structure of the device. In other embodiments not shown, the connecting structure of the device may exist at the perimeter of the base, rather than internal therein. According to the embodiment in FIG. 1a, the top surface of the base may include an inner chamber, shown as a concentric circle within the base. Other features of the top surface of the base are well-within the scope of invention to incorporate and support supra features of the device that may rest upon the base.

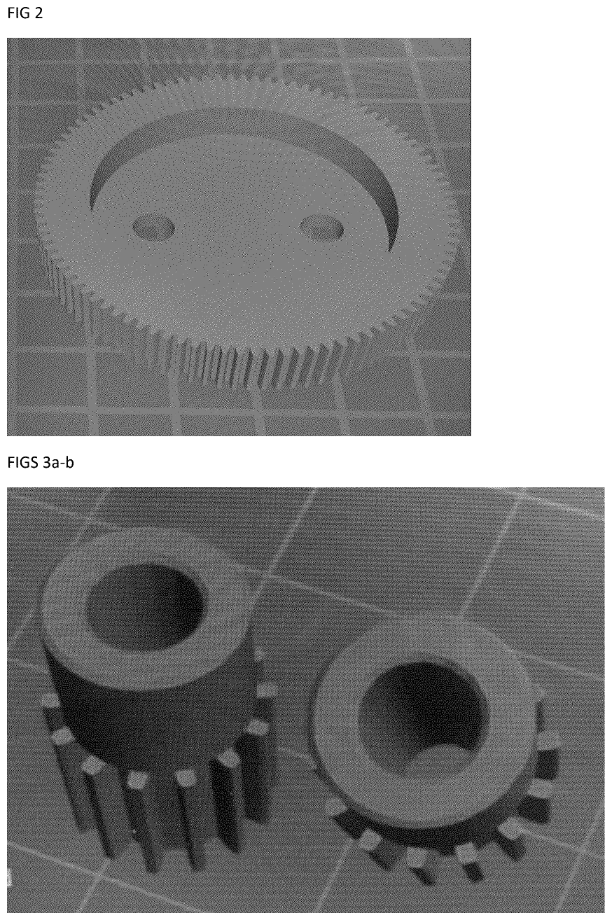

Looking at FIG. 2, a center or sun gear may be disposed atop of the base within the inner chamber of the base. The center gear is shown as being a disc-like shape, but may have other shapes in other embodiments of the invention. The center gear is shown as having a perimeter with a curved profile, with a gear profile at the perimeter having one or more cogs. Center gear may comprise a bottom and a top surface that may define one or more center gear openings capable of receiving a connecting screw, peg, cylinder, or other structure capable of tying together the features of the device described herein. According to the embodiment in FIG. 1a, the top surface of the center gear may include an inner chamber, shown as a concentric circle within the base. Other features of the top surface of the base are well-within the scope of invention to incorporate and support supra features of the device that may rest upon the center gear.

FIGS. 3a and 3b shown an embodiment of a spur gear or planetary gear. The spur gear is shown as being a cylindrical shape, but may have other shapes in other embodiments of the invention not shown. The spur gear may comprise a perimeter with a curved profile, with a gear profile at the perimeter having one or more cogs on an outer surface of the spur gear. The spur gear may comprise a bottom and a top surface that may define one or more spur gear openings capable of receiving a stump peg or stem, as may be seen in FIG. 8. Looking more closely at FIG. 3a, the perimeter having one or more cogs is shown to be partially smooth towards the top surface of the spur gear, above the gear profile, so that it resembles more of a hollow cylinder. The stump peg or stem in FIG. 8 may comprise an attaching end and a tooth end. In the embodiment illustrated in FIGS. 3a and 3b, the attaching end of the stump peg or stem may journal into the spur gear opening and seat into the hollow cylinder of the spur gear. In the present embodiment, the attaching end of the stem may frictionally fit into the hollow cylinder of the spur gear. In other embodiments of the invention the spur gear may mate with the attaching end of the stem or stump peg in any other configurations or structures known in the dental arts to mate such a structure to a dental restoration work stand. Within the device, the one or more spur gears may be disposed evenly around the center gear so that they may communicate circular rotation between the center gear and a ring gear, described as follows. In other embodiments not shown, the spur gear may communicate circular rotation to other portions of the device through structures not depicted, such undepicted structures being well-within the scope of invention. Spur gear, or securing element, may hold the stem in a fixed vertical position so it may be restricted from moving vertically. Securing element may further hold the stem at an angle from the horizon that is 90 degrees or perpendicular to the horizon, or at angles from 0-180 degrees from the horizon.

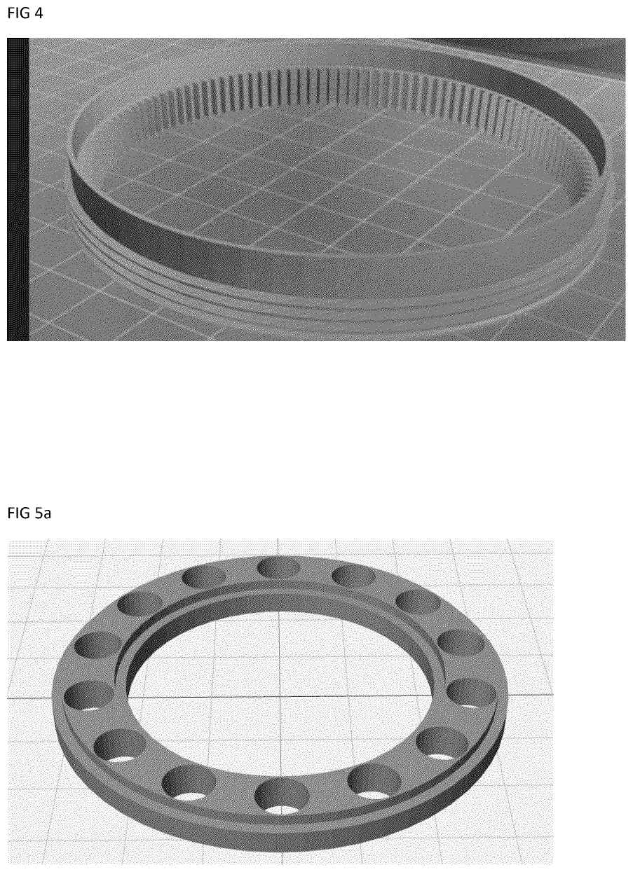

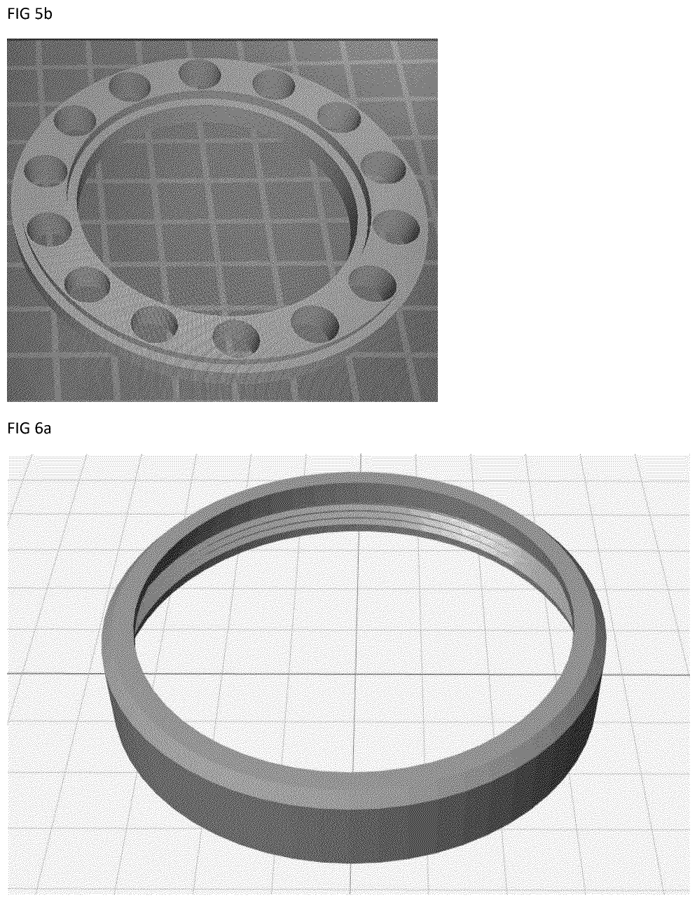

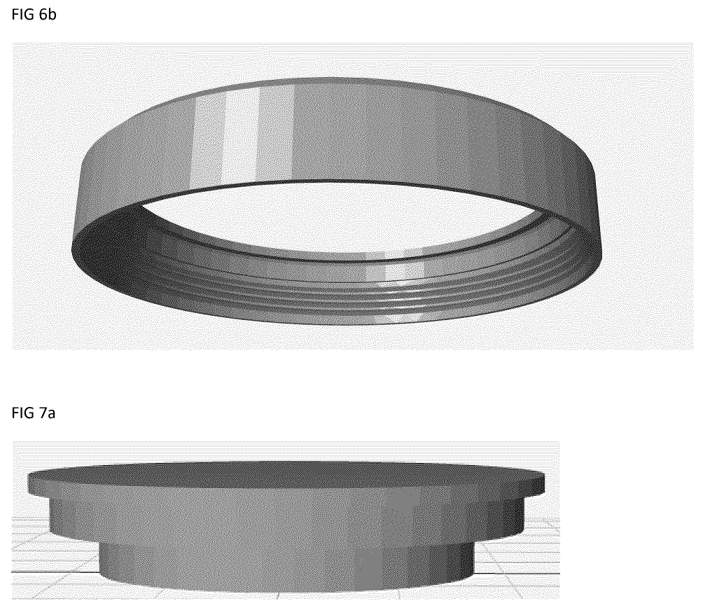

Looking now at FIG. 4, a ring gear is shown in an embodiment of the invention. Ring gear is shown as being a disc-like shape with an open interior section, but may have other shapes in other embodiments of the invention not shown. The ring gear may comprise a perimeter with a curved profile, with a gear profile being shown at an inner side of the perimeter and having one or more cogs. Ring gear may comprise a bottom and a top surface, as shown in FIG. 4 the gear profile is closer to the bottom surface than the top surface. In other embodiments not shown, the gear profile of the ring gear may be positioned in other configurations. Ring gear may further comprise an outer perimeter comprising a mating profile. As shown, mating profile includes a threaded portion towards the bottom surface for mating to a sleeve shown in FIGS. 6a and 6b. Sleeve is shown having a complementary structure at an inner perimeter to mate to the ring gear, so that they are essentially locked into a unitary structure as seen in FIG. 12a. Sleeve may at a top surface include a tapered lip that tapers internally over the open interior space. Though the illustrated embodiment shows the ring gear and sleeve as separate structures, they may also be constructed or manufactured as one, such as through 3D printing. As assembled in the device, ring gear may be positioned exterior of the spur gear, so that the gear profile on the inner side of the perimeter of the ring gear communicates circular motion with the one or more spur gear, ensuring that the spur gears may spin in a concurrent manner in unison.

FIGS. 5a and 5b show views of a cage. Cage is shown as being a disc-like shape with an open interior section, but may have other shapes in other embodiments of the invention not shown. The cage may comprise a perimeter with a curved profile. The cage may comprise a bottom and a top surface that may define one or more cage openings capable of receiving a stump peg or stem, as may be seen in FIG. 8. The top surface of the cage may further include a shelf at its perimeter of the cage. Cage may be disposed atop the at least one spur gear, directly or indirectly. As shown in FIG. 12a, Cage may be held in place by a sleeve or combined ring gear and sleeve. The shelf of cage may further rest against the lip of the sleeve in FIG. 6a.

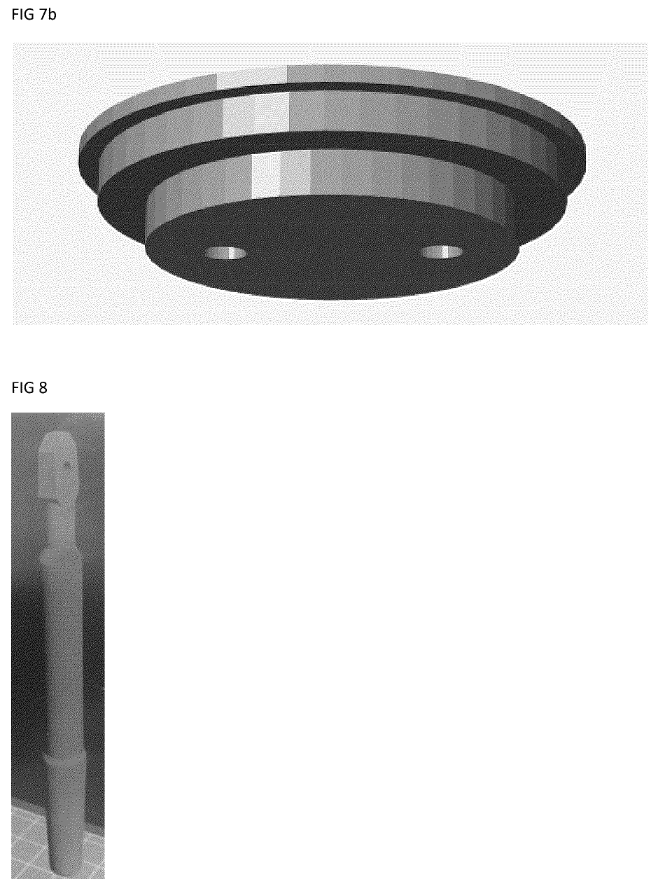

Looking at FIGS. 7a and 7b, a top piece or upper element is depicted. The upper element or top piece is shown as being a disc-like shape, but may have other shapes in other embodiments of the invention. The top piece is shown as having a perimeter with a curved profile. Top piece or upper element may comprise a bottom and a top surface that may define one or more upper element gear openings capable of receiving a connecting screw, peg, cylinder, or other structure capable of tying together the features of the device described herein. In the embodiment shown, Bottom surface of the top piece define the top piece opening, and the top surface is shown unbroken or solid. In other embodiments of the invention, the connecting structures of the device will necessitate a different geometric configuration of the openings or other structures to tie together elements of a device, as known in the arts. As shown in FIG. 7b, the top piece may comprise a first and second inner concentric portions. Beginning at the top surface, the perimeter is viewed as having the greater circumference than the first and second concentric portions. The first concentric portion may be disposed between the perimeter of the upper element and the second concentric portion, where the upper element openings may be positioned. As assembled in the FIG. 12a, top piece may seat into the internal opening of the cage and ring gear, so that the top piece openings may align and seat onto the base openings. In other embodiments of the invention, other configurations of the upper element are well within the scope of the invention. For example, top piece as shown may be reduced or even eliminated, giving greater transparency to an internal cavity of the device within the cage.

As depicted in FIGS. 1-12, the entire assembly device may be connected together by two screws or other vertical members journal therethrough the base, through the center gear and into the top.

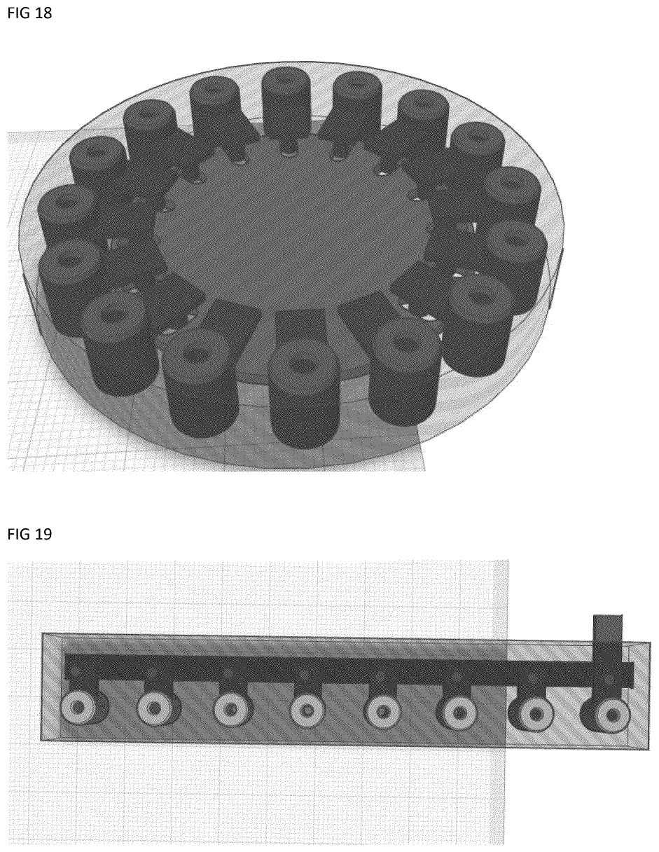

In another embodiment of the invention shown in FIG. 18, a device for rotating one or more artificial dental teeth is disclosed having a turning system that is accomplished without the use of gears. The device is shown as having a base that may have upper element and a lower element. The device may comprise an internal turning system as being a disc-like shape, but may have other shapes in other embodiments of the invention. The device is shown as having a perimeter with a curved profile. The turning system may comprise at least one securing element having a top surface and a bottom surface. As shown in FIG. 18, the top surface of the at least one securing element may define an opening of the securing element, into which an attaching end of a stem or stum peg may be positioned and secured. The securing element may have a turning system that comprises an arm extending in a direction distal from the shell perimeter, or towards the center of the device. The arm may include a joining element that may extend in a direction towards the bottom surface of the at least one securing element. The turning system of the device in FIG. 18 may further comprise a connecting element that connects with other arms of the at least one securing element in such a way that all of the at least one securing element are joined along a circumferential plane. The connecting element is shown in FIG. 18 as having a series of grooves that align with the arms of the at least one securing element. In other embodiments, the turning system may have other geometric configurations capable of joining the connecting elements, and thus the arms of the at least one securing element, such other geometric configurations being well-within the scope of invention. In use, as the upper is rotated against the upper element, arm will slide in the groove and turn to the side rotating the at least one securing element.

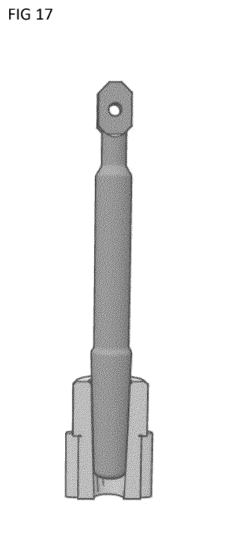

Looking more closely at FIGS. 8 and 17, the stump peg or stem has the attaching end that may seat securely in the spur gears seen in FIGS. 3a and 3b, or into securing elements and/or turning systems that accomplish the objective of spinning the stump pegs or stems in a circular motion through a geared system, other mechanical systems not depicted herein but capable of communicating circular rotation to said stump pegs or stems. The attaching end of stem is shown as being tapered to frictionally fit in the spur gear, the scope of attached end may include any geometric configuration that is complementary to a securing element. The tooth end of stump peg is shown as a convention structure in the arts upon which dental restorations are placed for construction and finishing. Other geometric configurations including those known in the arts of the tooth end of the stump peg are well within the scope of invention.

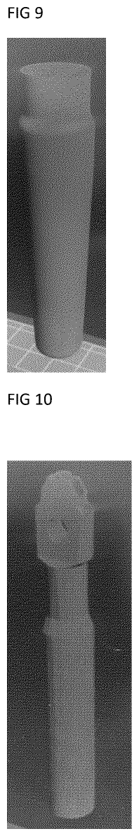

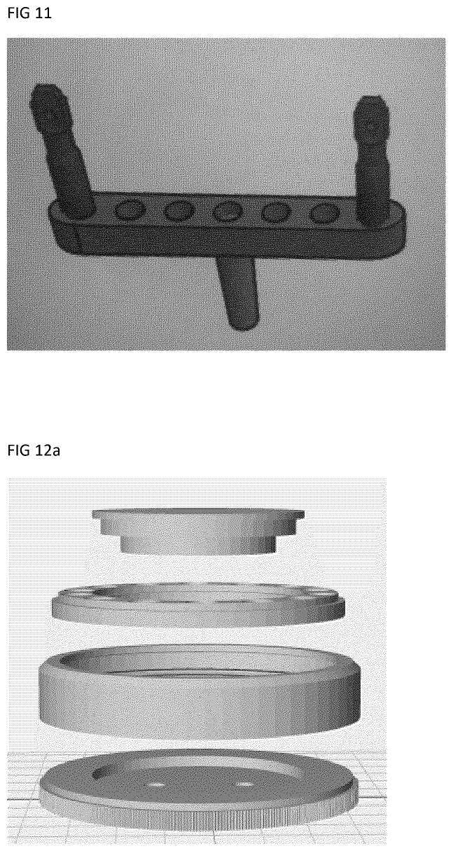

FIG. 9 shows a half or partial bottom peg that may seat not only in the spur gear but also is a bridge connector shown in FIG. 11 or FIG. 16, which may be placed atop the partial bottom peg. FIG. 10 shows a half or partial peg top that may be placed atop of bridge connectors.

As put into practice in an embodiment of the present invention, a method is designed for one or more spur gears above a base to communicate circular motion to stump pegs or stems so that the stump pegs may be prevented from moving individually and to move in unison as the spur/planetary gears orbit a sun gear. The ring gear may stabilize the spur gears to eliminate friction in the cage. The cage may seal the device to keep debris out of the base and help aid the assembly of the invention. Modular bridge connectors and pegs may be designed to create a custom dental restoration stand upon the device. Once the device and modular bridge connectors are assembled, the user may turn the lower element against the upper element so that the ring gear may be rotated to spin the planetary gears in union which hold the pegs and dental restoration allowing for quick access to all sides of the restorations.

In another embodiment shown in FIG. 19, a device may comprise a plurality of securing elements, connected by a connecting element. The device is depicted as being largely linear, but may have other geometric configurations, such as arcuate, or having portions that are linear and arcuate. The device in FIG. 19 may comprise a turning system comprising a lever, pulley, or other system known in the arts or capable of conveying rotational motion onto a generally cylindrical object such as a stump peg. The turning system may further comprise a mechanism that may convey arcuate motion short of rotational motion, that has the effect of turning the securing element and the stem therein in a direction up to 180 degrees from an original orientation, in either direction. Securing element may hold the stem in a fixed vertical position so it may be restricted from moving vertically. Securing element may further hold the stem at an angle from the horizon that is 90 degrees or perpendicular to the horizon, or at angles from 0-180 degrees from the horizon.

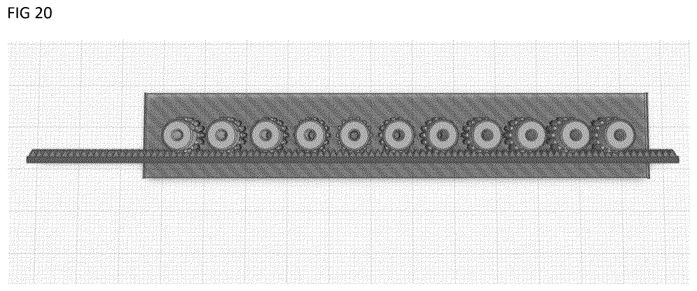

In yet another embodiment depicted in FIG. 20, a device may comprise a plurality of securing elements, connected by a connecting element. The device is depicted as being largely linear, but may have other geometric configurations, such as arcuate, or having portions that are linear and arcuate. The securing elements may comprise a spur gear or planetary gear. The spur gear is shown as being a cylindrical shape, but may have other shapes in other embodiments of the invention not shown. The spur gear may comprise a perimeter with a curved profile, with a gear profile at the perimeter having one or more cogs on an outer surface of the spur gear. The spur gear may comprise a bottom and a top surface that may define one or more spur gear openings capable of receiving a stump peg or stem, as may be seen in FIG. 20. The perimeter of the spur gear may comprise one or more cogs is shown to be partially smooth towards the top surface of the spur gear, above the gear profile, so that it resembles more of a hollow cylinder. the attaching end of the stump peg or stem may journal into the spur gear opening and seat into the hollow cylinder of the spur gear. In the present embodiment, the attaching end of the stem may frictionally fit into the hollow cylinder of the spur gear. In other embodiments of the invention the spur gear may mate with the attaching end of the stem or stump peg in any other configurations or structures known in the dental arts to mate such a structure to a dental restoration work stand. The device in FIG. 20 may further comprise a turning system comprising a gear track, that when advanced or retracted, may communicate circular motion to the plurality of securing elements. Securing element may hold the stem in a fixed vertical position so it may be restricted from moving vertically. Securing element may further hold the stem at an angle from the horizon that is 90 degrees or perpendicular to the horizon, or at angles from 0-180 degrees from the horizon.

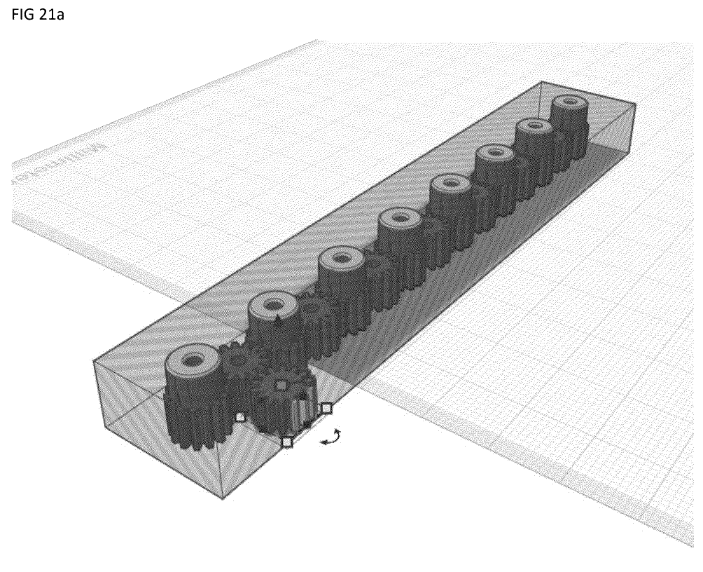

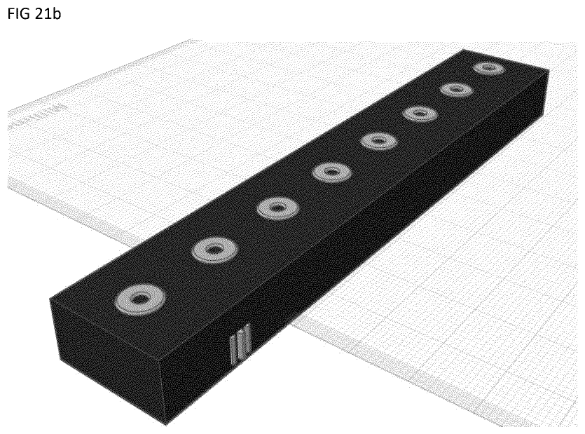

In still another embodiment depicted in FIGS. 21-22, a device may comprise a plurality of securing elements, connected by a connecting element. The device is depicted as being largely linear, but may have other geometric configurations, such as arcuate, or having portions that are linear and arcuate. The securing elements may comprise a spur gear or planetary gear. The spur gear is shown as being a cylindrical shape, but may have other shapes in other embodiments of the invention not shown. Securing element may hold the stem in a fixed vertical position so it may be restricted from moving vertically. Securing element may further hold the stem at an angle from the horizon that is 90 degrees or perpendicular to the horizon, or at angles from 0-180 degrees from the horizon. The spur gear may comprise a perimeter with a curved profile, with a gear profile at the perimeter having one or more cogs on an outer surface of the spur gear. The spur gear may comprise a bottom and a top surface that may define one or more spur gear openings capable of receiving a stump peg or stem, as may be seen in FIG. 21. The perimeter of the spur gear may comprise one or more cogs is shown to be partially smooth towards the top surface of the spur gear, above the gear profile, so that it resembles more of a hollow cylinder. the attaching end of the stump peg or stem may journal into the spur gear opening and seat into the hollow cylinder of the spur gear. In the present embodiment, the attaching end of the stem may frictionally fit into the hollow cylinder of the spur gear. In other embodiments of the invention the securing element of the spur gear may mate with the attaching end of the stem or stump peg in any other configurations or structures known in the dental arts to mate such a structure to a dental restoration work stand. The device in FIG. 21a may further comprise a turning system comprising a plurality of turning gears disposed between each of the spur gears. The turning system may further comprise a controlling gear that communicates circular motion to one of the turning gears. The turning gears may have a perimeter with a gear profile and at least one cog capable of engaging with any number of spur gears that are communicating with the turning gears. The controlling gear may, in other embodiments of the invention, be capable of communicating circular motion directly to a spur gear. When the controlling gear is advanced or retracted, it may communicate circular motion to the turning system, in various embodiments described herein, to a spur gear having a securing element, to a turning gear or indirectly to either using other connecting parts not shown. Looking at FIG. 21b, an exterior shell is applied to the device, the exterior shell having a top surface defining openings to the securing elements. The openings of the exterior shell may be the opening to the spur gear and securing elements itself, or be a façade on the exterior shell that aligns thereto. The exterior shell may further comprise and define a gear opening at its surface. In FIG. 21b, the gear opening is at a side of the exterior shell that is proximal to the turning gear of the FIG. 21a device. In use, a user may engage the turning gear at the gear opening and thus advance or retract the gear, in turn applying circular motion to the stump peg or stem.

The inventive system can be made in a number of ways, according to embodiments of the invention. It can be milled, cast, or printed, or assembled from constituent elements thereof, using any number or type of materials, both metallic and non-metallic. The user may design the number of spur gears needed, the number of resulting cage openings that would be needed accordingly, and thus the number of stump pegs or stems desired on the device. The user would then decide how many teeth are necessary for the spacing you would want and the speed of the rotation of the spur gears. The center of the spur gears may be designed to have a securing element for a stump peg to fit into it securely but passively. In another embodiment of the invention, an attaching end of the stump peg may comprise a key that may fit into a counter keyhole in the bottom of the spur gear, preventing the pegs from rotating individually. If, for example, a user desires the pegs to be arranged in a circle, one would calculate the number of teeth that would be needed in the center to create the desired space between the pegs. An outer ring gear would then need to be designed to encompass all of the spur gears. Once that is designed, the user would design a cage that will hold the spur gears in place. A top center section would be designed to hold the cage down on top of the spur gears. The ring gear would sit under an outer lip on the cage. The top holds the entire assembly together by way of an attachment to the bases. A sleeve may optionally be added for aesthetic purposes, but it is not necessary for this to function. In every embodiment described herein, the sleeve may also be eliminated. Further, the base and center gear can be made a single piece depending on manufacturing methods. In yet another embodiment, a handle could be added to the invention to possibly make it more ergonomic depending on one's preference.

In yet another embodiment, the spur gears could be arranged in different ways such as a straight line or an arch form. It would still perform the same function of having the pegs and dental restorations turn for case of glazing and staining.

The pegs and bridge pieces are to be assembled in any number of ways to fit user's specific needs. The dental restorations would then be fitted to the pegs with a putty. By way of example and not limitation, light cure putty may be utilized that matches the color of the prep shade sent by the doctor. In this example, the putty resembles a closer look to the natural patient anatomy so that it matches more closely in design. Pegs may be disposable, printed on demand, or created in large scale quantities to be sold with kits with the device. Further and in additional embodiments of the invention, pegs may go into furnace, be reusable, take it out of the firing tray and into the oven.

In yet another embodiment of the invention, the device may be used to display other items of interest to a hobbyist or small item builder. For example, the device may be used to display any number of small items that would be attached to the pegs, such as an artificial bug collection, figurines, game pieces, or fishing flies/hooks.

1. A device for rotating one or more artificial dental teeth, the device comprising
An upper element having top surface that defines at least one positioning opening capable of receiving a stem, the stem extending between an attaching end and a tooth end, the tooth end capable of holding one or more artificial dental teeth;
a lower element having a bottom surface, the lower element capable of moving in a circular motion in relationship with the upper element;
a securing element disposed between the top surface of the upper element and the bottom surface of the lower element, the securing element capable of securely holding the stem at a location proximal towards the attaching end within the device;
a turning system disposed between the top element and bottom element, the turning system capable of spinning the stem within the securing element; whereas by moving the lower element in a circular motion against the upper element, the turning system is thereby engaged to spin the stem within the securing element.

2. The device of claim 1, the upper element or the lower element having a disc-like shape with a perimeter having a surface with a gripping feature, whereas either the upper element or the lower element may be engaged to communicate a circular motion to the turning system.

3. The device of claim 1, the turning system comprising
a center sun gear comprising a curved perimeter having at least one cog;
a spur gear having a curved perimeter with at least one cog, the spur gear disposed exterior of and capable of communicating circular motion to the center sun gear;
a ring gear disposed exterior of the spur gear, the ring gear having a curved perimeter having at least one cog, the ring gear capable of communicating circular motion to the at least one cog of the spur gear.

4. The device of claim 3, the spur gear further having a top surface defining a securing element where stem seats into the spur gear.

5. The device of claim 4, whereas the stem, center sun gear, spur gear and ring gear are capable of communicating motion in a forward and reverse circular motion.

6. The device of claim 5 further comprising a cage disposed between the upper element and the turning system, the cage having a top surface and a bottom surface that define at least one opening capable of receiving the stem therethrough.

7. A modular bridge connector for use with the device of claim 1, the modular bridge connector capable of seating upon the tooth end of a stem, the modular bridge connector having a top surface and a bottom surface that define at least one opening capable of receiving the stem.

8. The modular bridge connector of claim 7 having a number of openings between 2 and 15.

9. The modular bridge connector of claim 7 further comprising a partial peg bottom stump for connecting between a modular bridge connector and the turning system, the modular bridge connector further comprising a partial peg top comprising a tooth end and an attaching end, the partial peg top capable of connecting a second modular bridge connector positioned atop the modular bridge connector, whereas the tooth end of the partial peg top is positioned distal of the modular bridge connector, the second modular bridge connector and the device, whereas the modular bridge connector is capable of supporting the assembly of a customized configuration of a dental restoration on a stem.

10. The device in claim 1 comprising one or more stems, whereas the one or more stems spin in unison.

11. The device in claim 4 comprising one or more stems, whereas the one or more stems spin in unison when the turning system is engaged.

12. The device in claim 9, the modular bridge connector, second modular bridge connector, partial peg top and partial peg bottom are capable of allowing assembly to fit a customized configuration of a dental restoration on a stem.

13. A device for rotating one or more artificial dental teeth, the device comprising
A stem extending between an attaching end and a tooth end of the stem, the tooth end of the stem capable of securing one or more artificial dental teeth;
a securing element capable of holding the stem in a fixed vertical position, the securing element capable of fixing the attaching end of the stem to the device; and
a turning system capable of turning the stem in an arcuate direction while remaining in a fixed vertical position; whereas the arcuate direction of the stem translates to a turning of the one or more artificial dental teeth.

14. A modular bridge connector for use with the device of claim 13, the modular bridge connector capable of seating upon the tooth end of a stem, the modular bridge connector having a top surface and a bottom surface that define at least one opening capable of receiving the stem.

15. The modular bridge connector of claim 13 further comprising a partial peg bottom stump for connecting between a modular bridge connector and the turning system, the modular bridge connector further comprising a partial peg top comprising a tooth end and an attaching end, the partial peg top capable of connecting a second modular bridge connector positioned atop the modular bridge connector, whereas the tooth end of the partial peg top is positioned distal of the modular bridge connector, the second modular bridge connector and the device, whereas the modular bridge connector is capable of supporting the assembly of a customized configuration of a dental restoration on a stem.

16. The device in claim 13 comprising a plurality of stems, whereas the plurality of stems spin in unison when the turning system is engaged.

17. The device in claim 13, the turning system capable of turning the stem in a full circular rotation.

18. The device in claim 16, the turning system further comprising a one or more joining elements, the one or more joining elements being positioned between each of the plurality of stems, the one or more joining elements being capable of conveying a turning motion to the plurality of stems, whereas by applying a turning motion to either an individual joining elements or to an individual stem, the turning motion is communicated to all of the one or more joining elements and the plurality of stems.

19. A method for positioning and rotating one or more artificial dental teeth, the method comprising:
Fixing a plurality of stump pegs into a base device that fixes the plurality of stump pegs in a vertical position;
Applying one or more unfinished artificial dental teeth to a stump peg;
Modify the construction of the unfinished artificial dental teeth;
Communicating a circular motion to the plurality of stump pegs while maintaining a fixed vertical position;
Conveying the circular motion from the plurality of stump pegs to the unfinished artificial teeth to position desirable to complete work on the unfinished artificial teeth.

20. The method in claim 19 further comprising the step of:
Optionally adding a modular bridge connector and connecting pieces between the base device and the unfinished artificial teeth.
